(19) United States
(12) Patent Application Publication
(10) Pub. No.: US 2011/0283078 A1
(43) Pub. Date: Nov. 17, 2011

(54) STORAGE APPARATUS TO WHICH THIN PROVISIONING IS APPLIED

(75) Inventors: Yuuhiko TAMURA, Yokohama (JP); Tomofumi SUGATA, Odawara (JP); Minori AWAKURA, Tokyo (JP)

(73) Assignee: HITACHI, LTD., Tokyo (JP)

(21) Appl. No.: 12/835,240

(22) Filed: Jul. 13, 2010

(30) Foreign Application Priority Data
May 14, 2010 (JP) 2010-111892

(51) Int. Cl. G06F 12/02; G06F 12/00

(52) U.S. Cl. 711/170; 711/E12.001; 711/E12.002

(57) ABSTRACT

At least two virtual volumes of a plurality of virtual volumes are associated with at least one pool. At least two pools of the plurality of pools are associated with each of virtual volumes. At least two pools that are associated with each of virtual volumes have a priority level. A storage control apparatus receives a write command and the write target data from a host apparatus. When a virtual area of a write destination specified by the write command is an unallocated virtual area, the storage control apparatus selects one pool based on the priority level of the pools that are associated with a virtual volume of a write destination specified by the write command. The storage control apparatus allocates an unallocated physical area in the selected pool to a virtual area of a write destination, and writes the write target data to the allocated physical area.

### BACKGROUND

The present invention generally relates to a storage apparatus to which Thin Provisioning is applied.

For a storage apparatus in general, a plurality of data storage media have been managed by using the RAID (Redundant Array of Independent/Inexpensive Disks) technique. The plurality of data storage media is managed in a unit of the RAID group. A storage area that is provided by the RAID group is logically delimited in some cases. The storage apparatus provides the storage area that is logically delimited (or the entire of the storage area that is provided by the RAID group) as a logical volume to a host apparatus (for instance, a system that is configured by at least one physical or virtual computer).

In recent years, in accordance with an increase in an amount of information, a storage apparatus to which Thin Provisioning (also called Dynamic Provisioning) is applied has been attracting attention. The storage apparatus provides virtual logical volume that is configured by a plurality of virtual pages (hereafter referred to as a virtual VOL) and is provided with a pool that is configured by a plurality of physical pages in general. In the case in which the storage apparatus writes data to a virtual page and a virtual page of a write destination is an unallocated virtual page, the storage apparatus allocates a physical page to the virtual page from a pool and writes the data of a write target to the allocated physical page. The unallocated virtual page is a virtual page to which a physical page is not allocated or a virtual page to which a physical page is not allocated in effect (for instance, a virtual page to which a specified physical page to which the specified data has been written is allocated).

For the Thin Provisioning as described above, taking the opportunity of a write of the data from the host apparatus, a part of a storage area of a pool (a physical page) is dynamically allocated to a virtual VOL. The virtual VOL is not a physical storage area but a virtual storage area that is defined in such a manner that a user can write to the storage area. A storage capacity of the virtual VOL can exceed a physical storage capacity of a storage apparatus.

In order to allocate a physical page from a pool, it is necessary that a free capacity of a pool is larger than zero. The free capacity of a pool is a total storage capacity of at least one free physical page (a physical page that can be allocated to a virtual page) for a pool.

As a method for increasing a free capacity of a pool, an extension of a pool capacity and a zero data deletion can be mentioned for instance.

The extension of a pool capacity is that a pool capacity is extended by increasing a number of physical pages that configure a pool.

The zero data deletion means that a physical page that has stored the zero data (data in which a value of each bit is “0”) of physical pages that are allocated to a virtual VOL is released from the virtual VOL. Since the released physical page becomes a free physical page, a free capacity of a pool is increased.

As a method for increasing a free capacity of a pool, a method that is disclosed by Patent Literature 1 can be mentioned moreover for instance. For the Patent Literature 1, in the case in which a capacity of a pool may be depleted in an environment in which a plurality of pools exists, the data is copied from the pool to another pool. Since a physical page of a copy source of the data is a free physical page, a free capacity of the pool is increased.
[Patent Literature 1] Japanese Patent Application Laid-Open Publication No. 2008-186172

### SUMMARY

In general, a plurality of virtual VOLs is associated with one pool (a ratio of the number of virtual VOLs and that of pools is N/1). However, in accordance with that a plurality of host apparatuses provided with different applications executes an I/O (input/output) to a plurality of virtual VOLs in this case, an I/O is concentrated on one pool. Consequently, an I/O is concentrated on a storage medium that is a basis of the pool. Moreover, in the case in which a failure occurs in the pool (for instance, a failure occurs in any storage medium that is a basis of the pool), all virtual VOLs that are associated with the pool are affected. Consequently, in consideration of the above, it is thought that pools should be separated for every application.

However, in the case in which pools are separated for every application, data from a plurality of host apparatuses is dispersed to a plurality of pools, whereby the efficiency in the use of a pool is degraded.

In the case in which pools are separated for every application, a physical page is allocated to a virtual VOL from only a pool that is corresponded to the application of the virtual VOL. Consequently, in the case in which an I/O is concentrated on a pool of an application and a free capacity of the pool is decreased in an unexpected fashion, a free capacity of the pool may be depleted even if a free capacity of pools of other applications is sufficient. In the case in which a free capacity of the pool is depleted, an operation that is corresponded to the application of the pool (for instance, an I/O to a virtual VOL) is stopped.

An object of the present invention is to prevent the efficiency in the use of a pool from being degraded and to prevent an operation from being stopped even in the case in which a free capacity of the pool is depleted.

There are a plurality of virtual volumes and a plurality of pools that is associated with the plurality of virtual volumes. Each of the virtual volumes is a virtual logical volume to which Thin Provisioning is applied, and is configured by a plurality of virtual areas. Each of the pools is a storage area that is configured by a plurality of physical areas based on the plurality of physical storage devices. At least two virtual volumes of the plurality of virtual volumes are associated with at least one pool of the plurality of pools. At least two pools of the plurality of pools are associated with each of virtual volumes. At least two pools that are associated with each of virtual volumes have a priority level. A storage control apparatus receives a write command and the write target data from a host apparatus. In the case in which a virtual area of a write destination that is specified by the write command is an unallocated virtual area, the storage control apparatus selects one pool from at least two pools based on the priority level of the at least two pools that are associated with a virtual volume of a write destination that is specified by the write command. The storage control apparatus allocates an unallocated physical area in the selected pool to a virtual area of a write destination, and writes the write target data to the allocated physical area.

The storage control apparatus can be a controller that is included in a storage apparatus and can be an apparatus that relays a communication between a storage apparatus and a host apparatus (for instance, a server apparatus or an intelligent switch device).

By the present invention, the efficiency in the use of a pool can be prevented from being degraded and an operation can be prevented from being stopped even in the case in which a free capacity of the pool is depleted.

### BRIEF DESCRIPTION OF THE DRAWINGS

FIG. 1 is a view showing a configuration example of a computer system in accordance with an embodiment of the present invention.

FIG. 2 is a view showing a detailed configuration example of a storage apparatus.

FIG. 3 is a schematic view showing an example of a relationship between a plurality of virtual volumes and a plurality of pools.

FIG. 4 is a schematic view showing an example of a plurality of pool VOLs that configure one pool and a relationship between the plurality of pool VOLs and a RAID group.

FIG. 5 is a view showing an example of a relationship between a virtual VOL and a pool that is associated with the virtual VOL.

FIG. 6 is a view showing a program and information in a memory.

FIG. 7 is a view showing a configuration example of a virtual VOL configuration management table.

FIG. 8 is a view showing a configuration example of a pool configuration management table.

FIG. 9 is a view showing a configuration example of a pool VOL configuration management table.

FIG. 10 is a view showing a configuration example of a RAID group configuration management table.

FIG. 11 is a view showing a configuration example of a virtual VOL map information table.

FIG. 12 is a view showing a configuration example of a pool map information table.

FIG. 13 is a flowchart showing a write process procedure.

FIG. 14 is a flowchart showing a free pool retrieval process procedure.

FIG. 15 is a flowchart showing a configuration optimization process procedure.

FIG. 16 is a flowchart showing a current pool modification process procedure.

FIG. 17 is a view showing a detailed correspondence relationship between a virtual page and a physical page in accordance with the virtual VOL map information table 22800 shown in FIG. 11.

FIG. 18 is a view showing a detailed configuration of each pool in accordance with the pool map information table 22900 shown in FIG. 12.

FIG. 19 is a view for illustrating a method for determining a priority level of a pool based on a degree of importance of a host apparatus (application).

### DETAILED DESCRIPTION OF THE EMBODIMENT

An embodiment for the present invention will be described below in detail with reference to the drawings. In the following descriptions, each king of information will be described for an expression of “xxx table”, and each king of information can also be expressed for a data configuration other than a table (for instance, a queue). The “xxx table” can also be called “xxx information” in order to indicate that each king of information does not depend on a data configuration.

In the following descriptions moreover, although a number is used as the identification information of a lot of kinds of targets, the identification information of other kinds (for instance, an alphabetical character, a numeric character, other signs, or a combination of them) can also be adopted.

In the following descriptions moreover, although a process will be described using a “program” as a subject in some cases, a program is executed by a processor (for instance, a CPU (Central Processing Unit)) and a defined process is executed by using a storage resource (for instance, a memory) and/or a communication interface device (for instance, a communication port) as needed, whereby a subject of a process can also be a processor. A process that is described using a program as a subject can also be a process that is executed by a controller of a storage apparatus. Moreover, a processor can also include a hardware circuit that executes a part or a whole of processes that are executed by the processor. A computer program can also be installed to each computer from a program source. A program source can also be a program distribution server or a storage medium for instance.

Moreover, an “application” that is described in the present embodiment is a series of operations that are executed by a host apparatus and that are defined by:

(A) at least one application program that is executed by a host apparatus, and
(B) at least one of (b1) the configuration information of the program, (b2) the data to be processed by the program, (b3) a content of a process request that is received by the program, and (b4) a frequency of receiving a process request by the program.

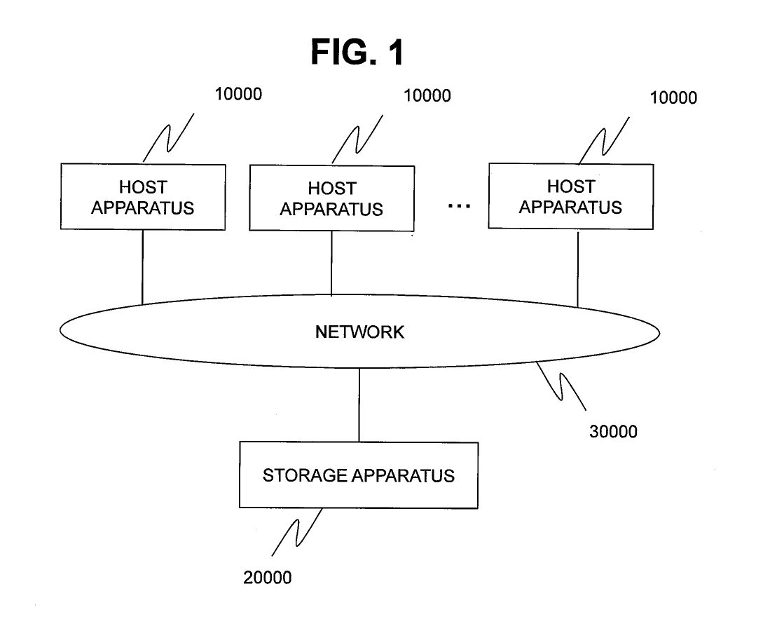

FIG. 1 is a view showing a configuration example of a computer system in accordance with an embodiment of the present invention.

For a computer system, a storage apparatus 20000 and a host apparatus 10000 are coupled with each other via a network 30000. The host apparatus 10000 is at least one physical computer such as a server, a work station, and a main frame, or at least one virtual computer to which a hardware resource (such as a processor and a memory) that is included in a physical computer is allocated for instance. The network 30000 is a SAN (Storage Area Network) or a LAN (Local Area Network) for instance.

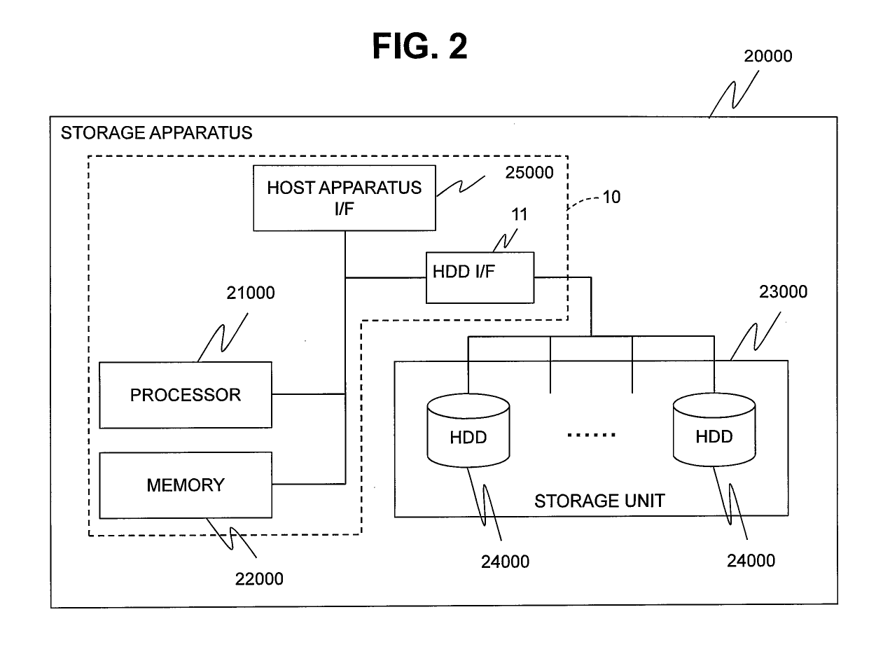

FIG. 2 is a view showing a detailed configuration example of a storage apparatus 20000.

The storage apparatus 20000 is provided with a controller 10 and a storage unit 23000 that is coupled to the controller 10.

The controller 10 is provided with the following elements for instance:

(*) an interface apparatus (host apparatus I/F) 25000 that is coupled with a host apparatus 10000 via a network 30000,
(*) an interface apparatus (HDD I/F) 11 that is coupled with a hard disk drive (hereafter referred to as an HDD) 24000 in a storage unit 23000,
(*) a processor 21000 that is configured to control elements in a storage apparatus 20000, and
(*) a memory 22000 that is used by the processor 21000.
The above elements are coupled with each other by an internal bus or the like.

The storage unit 23000 is a unit in which a data storage medium is stored, and is provided with a plurality of HDDs 24000 to be more precise. The plurality of HDDs 24000 is a configuration element of a plurality of RAID groups (not shown). Each of the RAID groups is configured by at least two HDDs, and stores data in the specified RAID level.

The HDD 24000 is an FC (Fibre Channel) disk drive, a SAS (Serial Attached SCSI) disk drive, a SATA (Serial Advanced Technology Attachment) disk drive or the like.

Although the HDD 24000 is used as a data storage medium in the present embodiment, other data storage medium such as a flash memory drive can also be used. Moreover, an external storage apparatus that is coupled with the storage apparatus 20000 can be a whole or a part of the storage unit 23000.

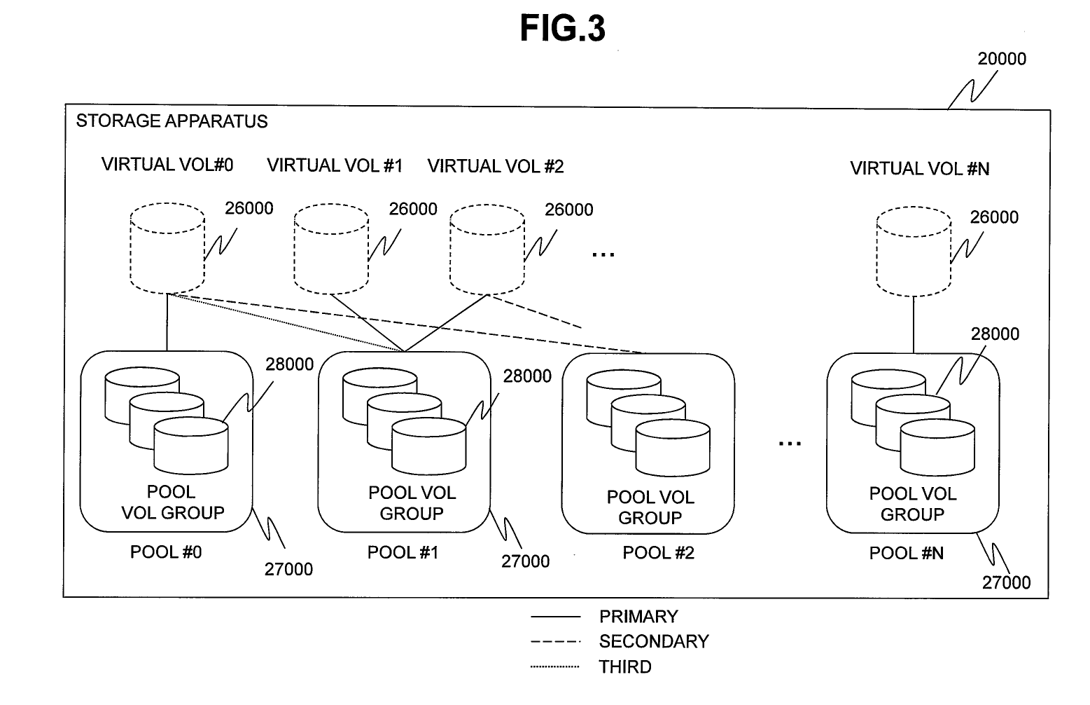

FIG. 3 is a schematic view showing an example of a correspondence relationship between a plurality of virtual VOLs 26000 and a plurality of pools 27000. In the following descriptions, a logical volume is abbreviated as VOL. In the following descriptions, a plurality of elements of the same kind can be distinguished by using an identification number of the element in some cases. In the case in which a plurality of elements A is distinguished, the elements A are described as “A#x” in some cases. “A#x” represents an element A having an identification number of x. The number “x” is an integer number equal to or larger than 0.

Each of the virtual VOLs 26000 is a virtual logical volume to which Thin Provisioning is applied, and is configured by a plurality of virtual pages. The virtual page is a virtual storage area and is an address range for instance. The address is an LBA (Logical Block Address) for instance.

In general, each of the pools 27000 is configured by a plurality of physical pages (physical storage areas). In the present embodiment, each of the pools 27000 is configured by at least one pool VOL 28000, and each of the pool VOLs 28000 is configured by at least two physical pages. In other words, each of the pools 27000 is a physical page group that is configured by a plurality of physical pages. Each of the pool VOLs 28000 is a VOL (a substantive VOL) based on the storage unit 23000.

At least one virtual VOL 26000 of a plurality of virtual VOLs 26000 is associated with at least one pool 27000 of a plurality of pools 27000.

On the other hand, at least one pool 27000 of a plurality of pools 27000 is associated with each of virtual VOLs 26000. At least two pools are associated with at least one virtual VOL. A pool that is associated with each of virtual VOLs 26000 has a priority level. The priority level is “primary”, “secondary”, and “third” in a descending order.

The priority level of a pool is not an absolute level, and is varied depending on a virtual VOL that is associated with in some cases. In other words, the priority level of a pool with which at least two virtual VOLs are associated is varied depending on the virtual VOL that is associated with in some cases. More specifically, as shown in FIG. 3 for instance, although the priority level of a pool #1 is “third” for a virtual VOL #0, the priority level of a pool #1 is “primary” for a virtual VOL #1.

In the following, a pool having a priority level of k is referred to as a “k pool” in some cases. More specifically, a pool having a priority level of “primary” is referred to as a “primary pool”, a pool having a priority level of “secondary” is referred to as a “secondary pool” and a pool having a priority level of “third” is referred to as a “third pool” in some cases. For instance, for the virtual VOL #0, a pool #0 is a primary pool, a pool #2 is a secondary pool, and a pool #1 is a third pool.

Any one of at least two pools that are associated with each of virtual VOLs 26000 is a current pool. The current pool is a current allocation source of a physical page. A physical page is allocated to a virtual page in a virtual VOL 26000 from a current pool for the virtual VOL 26000.

The current pool for each of virtual VOLs 26000 is a pool that has the highest priority level (that is, a primary pool) for the virtual VOL 26000 at first. Consequently, a current pool of the virtual VOL #0 is a pool #0, and a current pool of the virtual VOL #N is a pool #N at first for instance.

In the case in which a free capacity of a current pool is depleted for each of virtual VOLs 26000, a pool that has a priority level next to that of the current pool becomes a current pool. Consequently, for the virtual VOL #0, a current pool is changed from a pool #0 (a primary pool) to a pool #2 (a secondary pool), and a current pool is then changed from a pool #2 (a secondary pool) to a pool #1 (a third pool). In other words, for each of virtual VOLs, a current pool is varied depending on a priority level of a pool.

In accordance with the illustration of FIG. 3, pools are not separated for every application, and are associated with a plurality of virtual VOLs. Consequently, the efficiency in the use of a pool can be prevented from being degraded

In accordance with the illustration of FIG. 3 moreover, in the case in which it is necessary to allocate a physical page to a virtual page in a virtual VOL, another pool that is associated with the virtual VOL becomes a current pool and a physical page is allocated from the pool even if a free capacity of a current pool is depleted for the virtual VOL (even if the number of free physical pages is zero). Consequently, an operation can be prevented from being stopped even in the case in which a free capacity of a pool is depleted.

In the case in which the virtual VOL 26000 and the pool 27000 are associated with each other or a priority level of a pool is determined for each of virtual VOLs, a degree of importance of a host apparatus 10000 (application) can be made allowance for. The specific examples will be described in the following for instance. The association of a virtual VOL with a pool and/or a determination of a priority level of a pool for each of virtual VOLs can be executed by a human person (for instance, an administrator) or by the controller 10.

### Specific Example 1

A primary pool that is associated with the virtual VOL 26000 that is accessed (an I/O is executed) from a host apparatus having a high degree of importance (for instance, a highest degree of importance) is a pool dedicated for the virtual VOL 26000. Consequently, it is also possible that the primary pool is not associated with the other virtual VOLs 2600. More specifically, a memory 22000 can store a host management table (not shown) provided with a degree of importance and an identification number of a virtual VOL of an access destination for every host apparatus for instance. The controller 10 specifies a degree of importance of a host apparatus and a virtual VOL that is accessed by the host apparatus. It can also be controlled that other virtual VOLs are not associated with the primary pool that is associated with the specified virtual VOL. In accordance with the example of FIG. 3, since the pool #0 is not associated with a virtual VOL other than the virtual VOL #0, the pool #0 is a pool dedicated for the virtual VOL #0.

### Specific Example 2

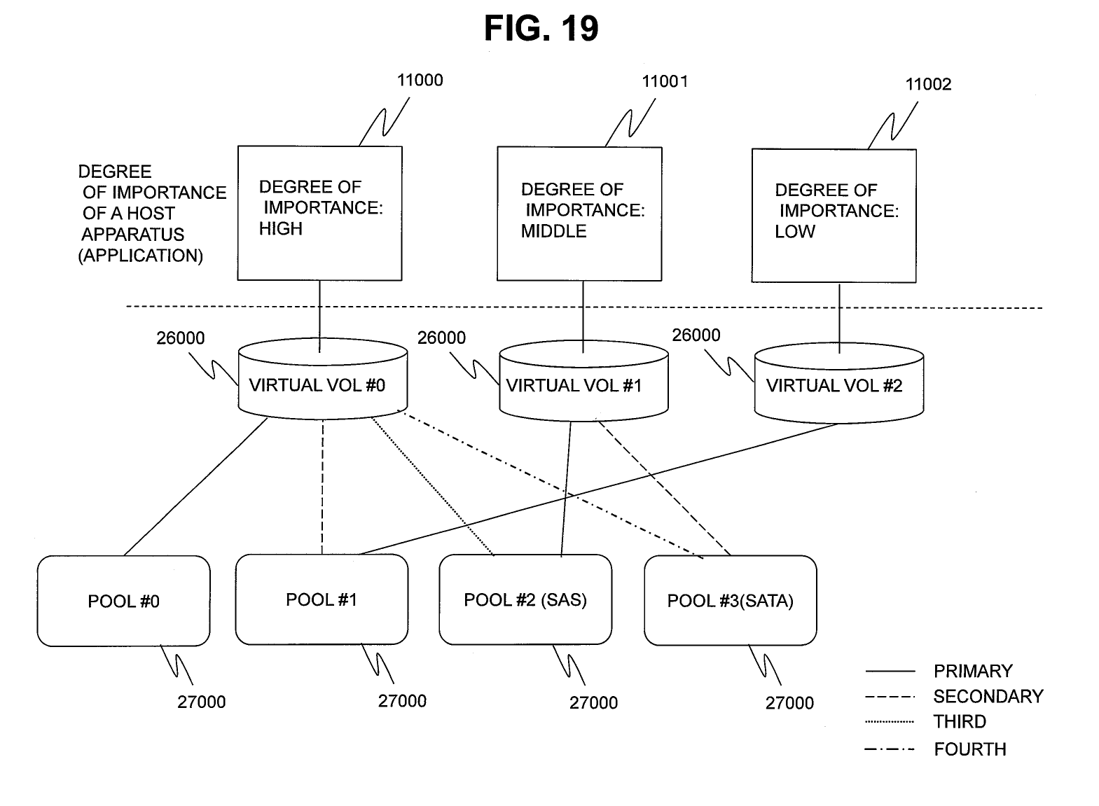

As shown in FIG. 19, a priority level of one pool of at least two pools that is associated with each of virtual VOLs is primary at first. After that, at least one priority level other than primary is determined for each of virtual VOLs based on a degree of importance of a host apparatus. More specifically, as a degree of importance of a host apparatus that accesses other virtual VOLs with which the pool is associated as a primary pool is lower, a priority level of a pool other than a primary pool for each of virtual VOLs is higher. In accordance with the example shown in FIG. 19, the virtual VOL #0 is associated with pools #0 to #3, and a priority level of the pools #1 to #3 other than a primary pool #0 will be determined as shown in the following based on the host management table described above. In the following descriptions, a degree of importance can be classified into three stages: “high”, “middle”, and “low”. A degree of importance can also be composed of less than three stages or larger than three stages. In the following descriptions moreover, a host apparatus (application) having a degree of importance of “high” is called a high host apparatus, a host apparatus (application) having a degree of importance of “middle” is called a middle host apparatus, and a host apparatus (application) having a degree of importance of “low” is called a low host apparatus.

(*) The controller 10 specifies the virtual VOL #2 that is accessed by a low host apparatus, and specifies the pool #1 that is associated with the virtual VOL #2. The controller 10 determines a priority level of the pool #1 as secondary for the virtual VOL #0.
(*) The controller 10 specifies the virtual VOL #1 that is accessed by a middle host apparatus, and specifies the pools #2 and #3 that are associated with the virtual VOL #1. The controller 10 determines a priority level of each of at least two pools (#2 and #3) having the same degree of importance of a host apparatus based on an attribute of the at least two pools (#2 and #3). The attribute can also be an access performance of a pool (a speed of an input and an output of data) or an attribute that affects the access performance (for instance, a kind of an HDD that is a basis of a pool). More specifically, a pool having a higher access performance can also have a higher priority level. In accordance with the example of FIG. 19, the pool #2 is based on a SAS HDD, and the pool #3 is based on a SATA HDD having an access performance lower than that of the SAS HDD. Consequently, a priority level of the pool #3 is fourth, and a priority level of the pool #2 is third that is higher than that of the pool #3.

In accordance with the specific example 2, for the virtual VOL #0, a priority level of the pool #1 that is associated with a virtual VOL that is accessed from the low host apparatus is higher than that of the pool #2 that is associated with a virtual VOL that is accessed from the middle host apparatus. The reason is that an influence of a depletion of a free capacity of a pool that is associated with a virtual VOL that is accessed from a host apparatus having a low degree of importance is smaller that that of a depletion of a free capacity of a pool that is associated with a virtual VOL that is accessed from a host apparatus having a high degree of importance.

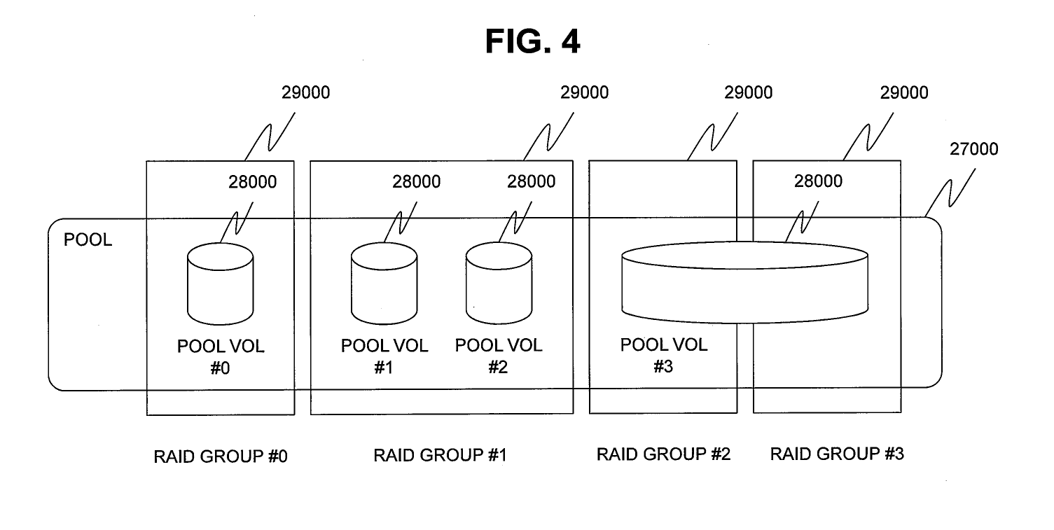

FIG. 4 is a schematic view showing an example of a plurality of pool VOLs 28000 that configure one pool 27000 and a relationship between the plurality of pool VOLs 28000 and a RAID group 29000.

At least one VOL is created based on at least one RAID group 29000. In other words, one VOL can be created based on one RAID group, or can be created based on a plurality of RAID groups. Moreover, a plurality of VOLs VOL can also be created based on one RAID group.

In FIG. 4 for instance, one pool 27000 is configured by four pool VOLs #0 to #3. One pool VOL #0 is created based on one RAID group #0. Moreover, two pool VOLs #1 and #2 are created based on one RAID group #1. Moreover, one pool VOL #3 is created based on two RAID groups #2 and #3. The pool VOL #3 can be a VOL (an extended logical VOL) in which a VOL that is created based on the RAID group #2 and a VOL that is created based on the RAID group #3 are coupled with each other.

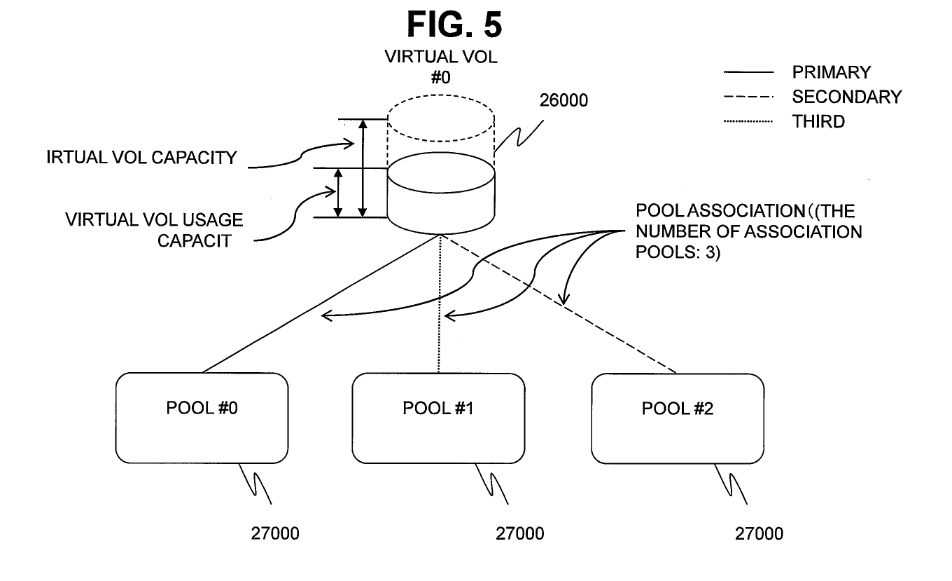

FIG. 5 is a view showing an example of a relationship between a virtual VOL 26000 and a pool 27000 that is associated with the virtual VOL 26000.

The total of three pools of a pool #0 (a primary pool), a pool #1 (a third pool), and a pool #2 (a secondary pool) are associated with one virtual VOL 26000.

A physical page is not allocated to the virtual VOL 26000 at the time point when a virtual VOL capacity (a storage capacity of a virtual VOL) is defined at first. Taking the opportunity of a write of the data from the host apparatus 10000 to the virtual VOL 26000, a physical page is allocated to an unallocated virtual page of a write destination from a current pool of three pools 27000.

In other words, a “page” is a minimum unit in the case in which a storage area is allocated, and a physical page in a pool 27000 is dynamically allocated to a virtual page of a write destination in the virtual VOL 26000. A numerical value in which the total sum of virtual pages that have been allocated for the virtual VOL 26000 (virtual pages to which a physical page has been allocated) is converted into a capacity is a “virtual VOL usage capacity”.

A pool 27000 that is associated with the virtual VOL 26000 and that has a higher priority level can be a current pool on a priority basis. Consequently, a primary pool #0 is a current pool at first, and a secondary pool #2 becomes a current pool in the case in which a free capacity of the primary pool #0 is depleted. After that, a third pool #1 becomes a current pool in the case in which a free capacity of the secondary pool #2 is depleted.

However, in the case in which a free capacity of the primary pool #0 is depleted in the above described environment and a physical page is allocated to the virtual VOL #0 from the secondary pool #2 and/or the third pool #1 without a limit, other virtual VOLs in which the secondary pool #2 and/or the third pool #1 are primary pools (a host apparatus that utilizes the virtual VOL) are affected

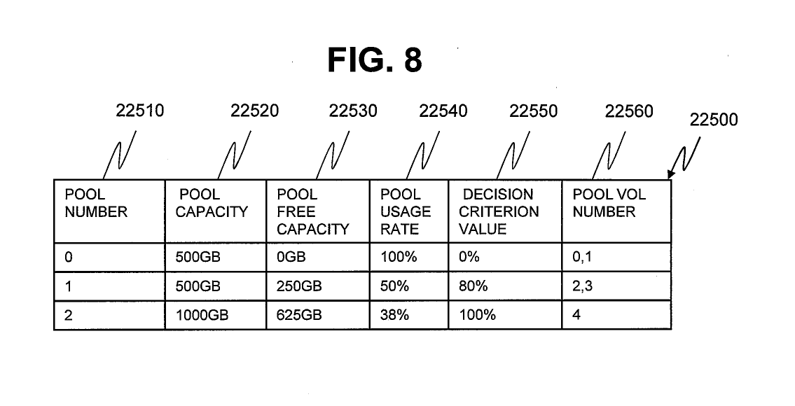

In the present embodiment, a decision criterion value is given for every pool. In the case in which a current pool is a pool other than a primary pool and a usage rate of the pool is equal to or larger than the decision criterion value of the pool, a physical page is not allocated to the virtual VOL from the pool. In other words, an allocation of a physical page to a virtual VOL from a pool other than a primary pool is limited in order to ensure a physical page that will be allocated to other virtual VOLs in which the pool is a primary pool. The detailed method will be described in detail later with reference to FIG. 8. A usage rate of a pool is a ratio of a usage capacity of a pool to a capacity of a pool. A usage capacity of a pool is a total capacity of physical pages that are allocated to a virtual VOL for the pool.

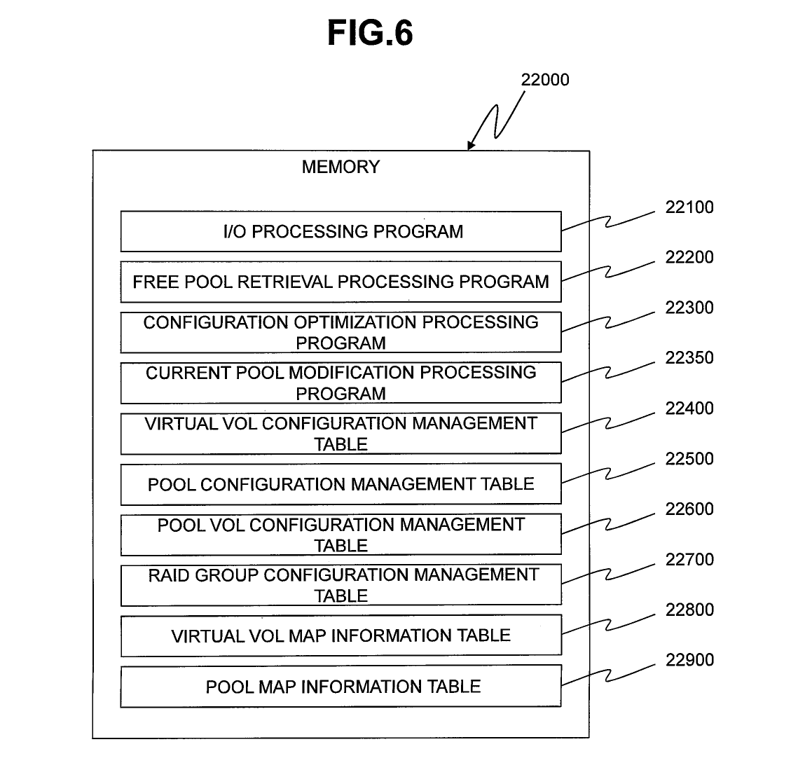

FIG. 6 is a view showing a program and information in a memory 22000.

The memory 22000 stores the following computer programs and information:

(*) an I/O processing program 22100 that processes an I/O request (a write request and a read request) from a host apparatus;
(*) a free pool retrieval processing program 22200 that retrieves a pool provided with a free capacity in the case in which a free capacity of a current pool is depleted;
(*) a configuration optimization processing program 22300 that returns data in a pool other than a primary pool to a primary pool after a free capacity of a primary pool in which a free capacity has been depleted is increased;
(*) a current pool modification processing program 22350 that modifies a current pool;
(*) a virtual VOL configuration management table 22400 that is provided with information related to each of virtual VOLs;
(*) a pool configuration management table 22500 that is provided with information related to each of pools;
(*) a pool VOL configuration management table 22600 that is provided with information related to each of pool VOLs;
(*) a RAID group configuration management table 22700 that is provided with information related to each of RAID groups;
(*) a virtual VOL map information table 22800 that is provided with information that indicates a correspondence relationship between a virtual page and a physical page; and
(*) a pool map information table 22900 that is provided with information related to a status of each of physical pages (whether a physical page has been allocated or not).
However, it is also possible that the pool VOL configuration management table 22600 and the RAID group configuration management table 22700 are not directly utilized for each of the above programs.

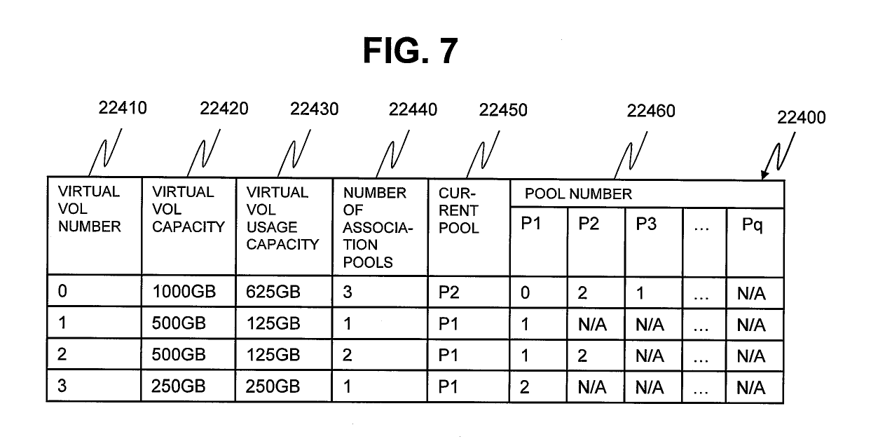

FIG. 7 is a view showing a configuration of the virtual VOL configuration management table 22400.

The virtual VOL configuration management table 22400 is provided with the following information for every virtual volume:

(*) a virtual VOL number 22410 that is an identification number of a virtual volume;
(*) a virtual VOL capacity 22420 that is a value indicating a capacity of a virtual volume;
(*) a virtual VOL usage capacity 22430 that is a value indicating a usage capacity of a virtual volume;
(*) the number of association pools 22440 that is a value indicating the number of pools that are associated with a virtual volume;
(*) a current pool 22450 that is a value indicating a pool priority level that is currently adopted for a virtual volume; and
(*) a pool number 22460 that indicates a pool that is associated with a virtual volume and a priority level of the pool.

As described above, the usage capacity of a virtual volume is a numerical value in which the total sum of virtual pages to which a physical page has been allocated is converted into a capacity, that is, the total capacity of virtual pages to which a physical page has been allocated.

The number of association pools 22440 indicates the total number of pools that are registered to the pool number 22460 (the total number other than N/A for instance).

The pool number 22460 is configured by q columns (q is an integer number equal to or larger than 1). Each column is provided with Pq that is a value indicating a priority level q (P of Pq is an abbreviation of “Priority”) and an identification number of a pool that is corresponded to Pq. For instance, P1, P2, and P3 represent a primary pool, a secondary pool, and a third pool, respectively. The maximum q pools can be associated with each of virtual VOLs. In the case in which the number of pools that are associated with a virtual VOL is less than q, a value that indicates that a pool is not associated (N/A for instance) is registered to a column that is corresponded to at least lowest priority level.

In accordance with the example shown in FIG. 7, the following can be found for the virtual VOL #0:

(*) the number of pools that are associated is 3 (a primary pool, a secondary pool, and a third pool);
(*) a capacity of the virtual VOL #0 is 1000 GB;
(*) a usage capacity of the virtual VOL #0 is 625 GB;
(*) a primary pool is a pool #0 (P1 is “0”), a secondary pool is a pool #2 (P2 is “2”), and a third pool is a pool #1 (P3 is “1”); and
(*) a current pool is a secondary pool (a current pool 22450 is P2).

FIG. 8 is a view showing a configuration of the pool configuration management table 22500.

The pool configuration management table 22500 is provided with the following information for every pool:

(*) a pool number 22510 that is an identification number of a pool;
(*) a pool capacity 22520 that is a value indicating a capacity of a pool;
(*) a pool free capacity 22530 that is a value indicating a free capacity of a pool;
(*) a pool usage rate 22540 that is a value indicating a usage rate of a pool;
(*) a decision criterion value 22550 that is a threshold value (a decision criterion value) that is compared with a usage rate of a pool other than a primary pool; and
(*) a pool VOL number 22560 that is an identification number of a pool VOL 28000 that configures a pool.

The pool capacity 22520 is a capacity of a pool. More specifically, the pool capacity 22520 is a value that is obtained by subtracting a capacity of a specified area (for instance, an area in which data from a host apparatus is not stored, such as a management area that stores specified information) from the total sum of capacities of pool VOLs that configure a pool.

The pool free capacity 22530 is a numerical value in which the total sum of physical pages that have been unallocated for a pool (free physical pages) is converted into a capacity.

The decision criterion value 22550 can be any value in the range of 0% to 100%. Here, 0% can also be represented by another value that corresponds to 0%, such as N/A. In the case in which a pool in which the decision criterion value 22550 is 0% is a pool other than a primary pool, a physical page is not allocated from the pool even if the pool is provided with a free capacity. On the other hand, even in the case in which a pool in which the decision criterion value 22550 is 100% is a pool other than a primary pool, a physical page is allocated from the pool if the pool is provided with a free capacity.

The decision criterion value 22550 can be determined depending on a degree of importance of a host apparatus (application) that accesses a virtual VOL with which the corresponded pool is associated as a primary pool for instance. More specifically, a determination as described in the following can be carried out. In the following descriptions, a host apparatus (operation) in which a degree of importance is classified as “high” is referred to as a “high host apparatus”, a host apparatus (operation) in which a degree of importance is classified as “middle” is referred to as a “middle host apparatus”, and a host apparatus (operation) in which a degree of importance is classified as “low” is referred to as a “low host apparatus”.

(*) It is preferable that a primary pool of a virtual VOL that is accessed by the high host apparatus (referred to as a “pool X” in this stage) is utilized as a pool dedicated to a virtual VOL. In other words, it is not preferable that a physical page is allocated from the pool X to a virtual VOL that is accessed by the middle host apparatus or the low host apparatus. Consequently, the decision criterion value 22550 of the pool X is 0%. Therefore, a physical page is not allocated from the pool X to a virtual VOL that is accessed by the middle host apparatus or the low host apparatus, and a physical page in the pool X is allocated only to a virtual VOL that is accessed by the high host apparatus.
(*) It is not necessary that a primary pool of a virtual VOL that is accessed by the low host apparatus (referred to as a “pool Y” in this stage) is a pool dedicated to the virtual VOL. In other words, a physical page can be allocated without a limit from the pool Y to a virtual VOL that is accessed by the high host apparatus and the middle host apparatus. Consequently, the decision criterion value 22550 of the pool Y is 100%.

Therefore, a physical page is allocated without a limit from the pool Y to a virtual VOL that is accessed by the high host apparatus or the middle host apparatus until a pool capacity is depleted.

(*) A capacity other than capacities that are expected to be used by the middle host apparatus at the very least by a certain time point in the future among capacities of a primary pool of a virtual VOL that is accessed by the middle host apparatus (referred to as a “pool Z” in this stage) can be used for a storage of data from the high host apparatus or the middle host apparatus. In other words, the decision criterion value 22550 of the pool Z can be determined based on a pool usage capacity that is expected by a certain time point in the future. For instance, in the case in which a capacity of the pool Z is 500 GB, a pool usage rate of the pool Z is 60% (a usage capacity is 300 GB), and it is expected that up to 400 GB will be consumed by the middle host apparatus one year later, the decision criterion value 22550 of the pool Z is 80%. Consequently, in the case in which a pool usage rate 22540 of the pool Z exceeds 80%, a physical page is not allocated to a virtual VOL that is accessed by the high host apparatus or the low host apparatus. After that, unless a pool usage rate of the pool Z is less than 80%, a physical page is allocated from the pool Z to only a virtual VOL that is accessed by the middle host apparatus. Therefore, even in the case in which a physical page is allocated from the pool Z to a virtual VOL that is accessed by the high host apparatus or the low host apparatus, an influence to the middle host apparatus can be reduced.

Regardless of the decision criterion value of a primary pool that is associated with a virtual VOL that is accessed by the first host apparatus (hereafter referred to as a “pool J” in this stage), the following control can be executed. In other words, it is possible that a physical page can be allocated to a virtual VOL that is accessed by the second host apparatus (a host apparatus provided with a degree of importance higher than that of the first host apparatus) and a physical page cannot be allocated to a virtual VOL that is accessed by the third host apparatus (a host apparatus provided with a degree of importance lower than that of the first host apparatus). Consequently, it can be prevented that data cannot be written to the pool J since data is written to the pool J from the third host apparatus provided with a degree of importance lower than that of the first host apparatus.

The determination of the decision criterion value based on the above point of view can be executed by a human person (for instance, an administrator) or by the controller 10. In the case of the latter, the controller 10 can determines the decision criterion value of each of pools based on the above described host management table (information that indicates a degree of importance of a host apparatus and a virtual VOL that is accessed by the host apparatus provided with the degree of importance).

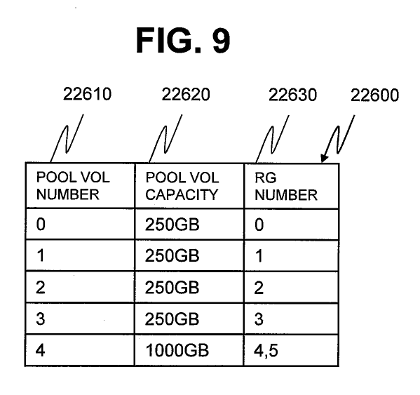

FIG. 9 is a view showing a configuration of the pool VOL configuration management table 22600.

The pool VOL configuration management table 22600 is provided with the following information for every pool VOL:

(*) a pool VOL number 22610 that is an identification number of a pool VOL;
(*) a pool VOL capacity 22620 that is a value indicating a capacity of a pool VOL; and
(*) an RG number 22630 that is an identification number of a RAID group that is a basis of a pool VOL.

In accordance with the example shown in FIG. 9, the following can be found for the pool VOL #0:

(*) a capacity of the pool VOL #0 is 250 GB; and
(*) the pool VOL #0 is based on a RAID group #0.

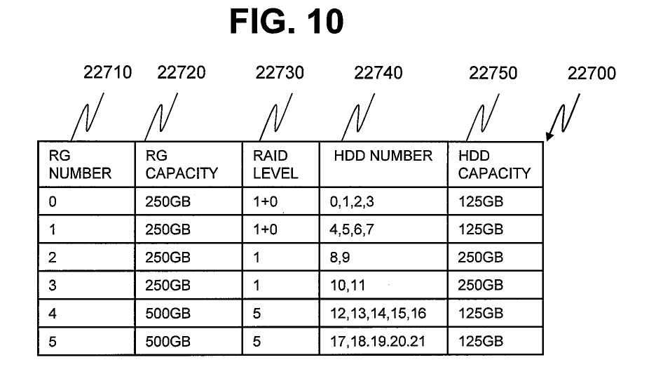

FIG. 10 is a view showing a configuration of the RAID group configuration management table 22700.

The RAID group configuration management table 22700 is provided with the following information for every RAID group:

(*) an RG number 22710 that is an identification number of a RAID group;
(*) an RG capacity 22720 that is a value indicating a capacity of a RAID group (a capacity that can utilized as a VOL);
(*) a RAID level 22730 that is a value indicating a RAID level of a RAID group;
(*) an HDD number 22740 that is an identification number of an HDD 24000 that configures a RAID group; and
(*) an HDD capacity 22750 that is a value indicating a capacity of an HDD 24000 that configures a RAID group.

In accordance with the example shown in FIG. 10, the following can be found for the RAID group #0:

(*) a RAID level of the RAID group #0 is “1+0”;
(*) there are four HDDs that configure the RAID group #0, and the HDD numbers of the HDDs are “0”, “1”, “2”, and “3”;
(*) a capacity of each of the HDDs that configure the RAID group #0 is 125 GB; and
(*) although the total capacity of the HDDs that configure the RAID group #0 is 500 GB (125 GB (a capacity of each of the HDDs)×4 (the number of HDDs)), a capacity that can be utilized as a VOL is 250 GB (a half of 500 GB) since the RAID level is “1+0”.

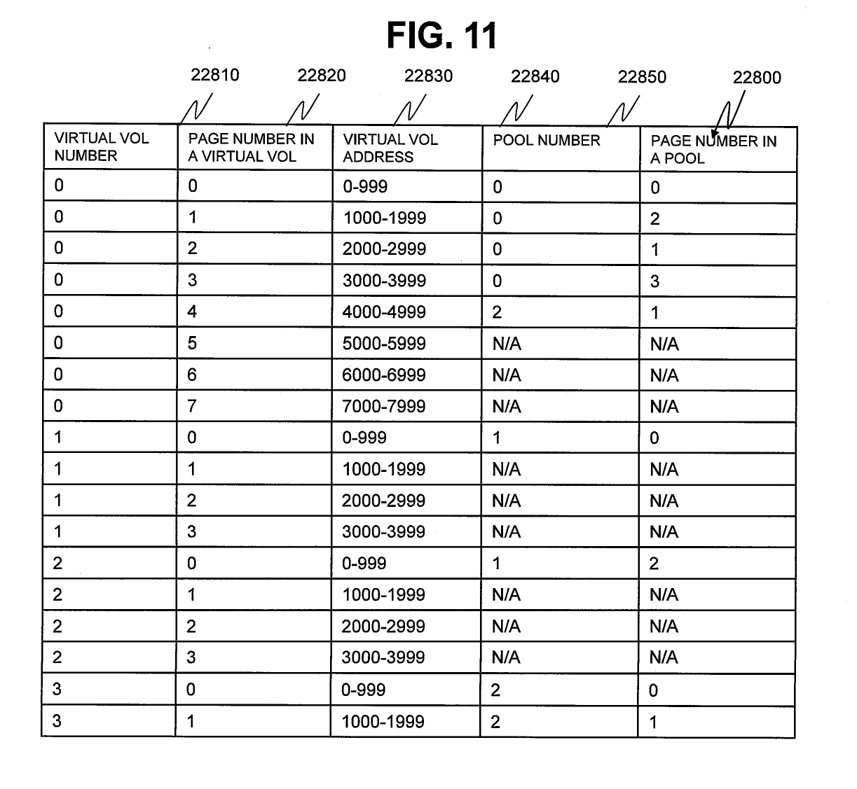

FIG. 11 is a view showing a configuration of the virtual VOL map information table 22800.

The virtual VOL map information table 22800 is provided with the following information for every virtual page:

(*) a virtual VOL number 22810 that is an identification number of a virtual VOL provided with a virtual page;
(*) a page number 22820 in a virtual VOL, which is an identification number of a virtual page for a virtual VOL provided with a virtual page;
(*) a virtual VOL address 22830 that is a value indicating an address range of a virtual page for a virtual VOL provided with a virtual page;
(*) a pool number 22840 that is an identification number of a pool provided with a physical page that is allocated to a virtual page; and
(*) a page number 22850 in a pool, which is a value indicating an identification number in a pool provided with a physical page for the physical page that is allocated to a virtual page.

The pool number 22840 (the page number 22850 in a pool) indicates a value meaning that there is no allocated physical page (for instance, N/A) in the case in which a physical page is not allocated to a virtual page.

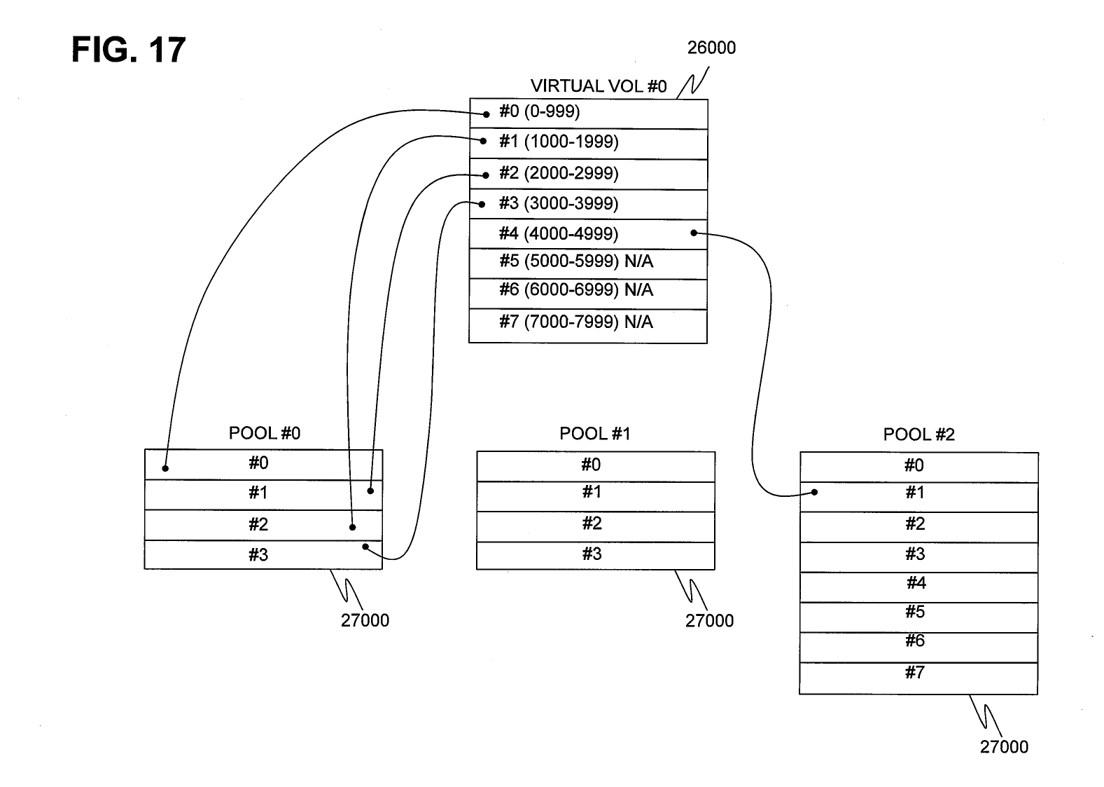

In accordance with the virtual VOL map information table 22800 shown in FIG. 11, the correspondence relationship shown in FIG. 17 can be indicated. In other words, it is found that a physical page #0 in a pool #0 is allocated to a virtual page #0 in a virtual VOL #0 (address range; 0 to 999) for instance. Moreover, it is found that a physical page #1 in a pool #2 is allocated to a virtual page #4 (address range; 4000 to 4999) for instance. Furthermore, it is found that a physical page is not allocated to a virtual VOL #0 from a pool #1 for instance.

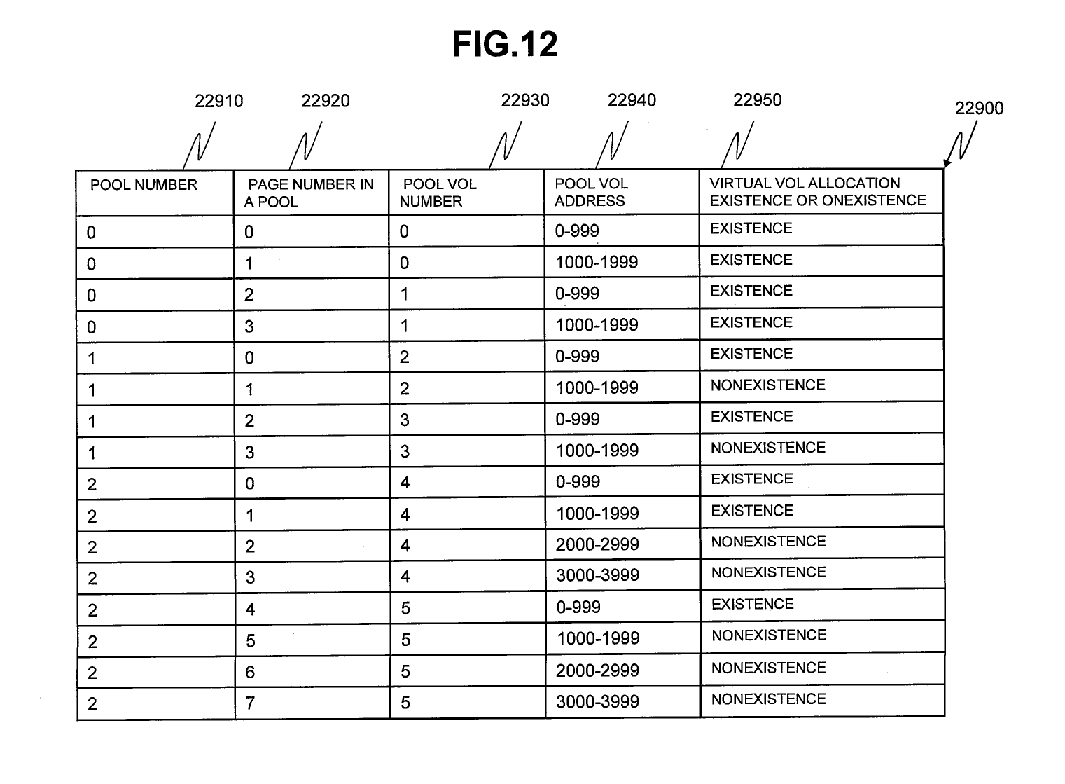

FIG. 12 is a view showing a configuration of the pool map information table 22900.

The pool map information table 22900 is provided with the following information for every physical page:

(*) a pool number 22910 that is an identification number of a pool provided with a physical page;
(*) a page number 22920 in a pool, which is an identification number of a physical page for a pool provided with a physical page;
(*) a pool VOL number 22930 that is an identification number of a pool VOL provided with a physical page;
(*) a pool VOL address 22940 that is a value indicating an address range of a physical page for a pool VOL provided with a physical page; and
(*) a virtual VOL allocation existence or nonexistence 22950 that indicates whether or not a physical pool is allocated to a virtual VOL.

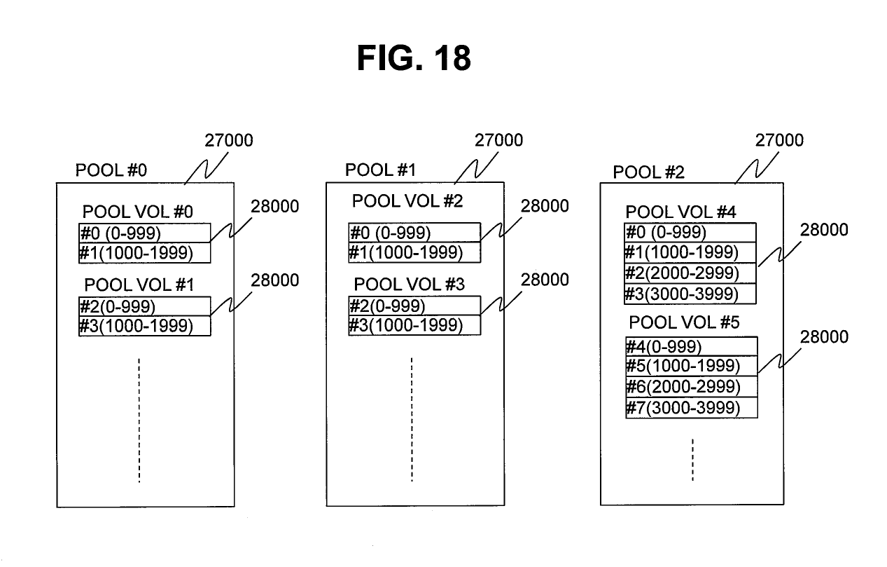

In accordance with the pool map information table 22900 shown in FIG. 12, the configuration shown in FIG. 18 can be indicated. In other words, it is found that a physical page #0 in a pool #0 is an area in the address range of 0 to 999 of a pool VOL #0 for instance. Moreover, it is found that a physical page #0 in a pool #2 is an area in the address range of 0 to 999 of a pool VOL #4 for instance.

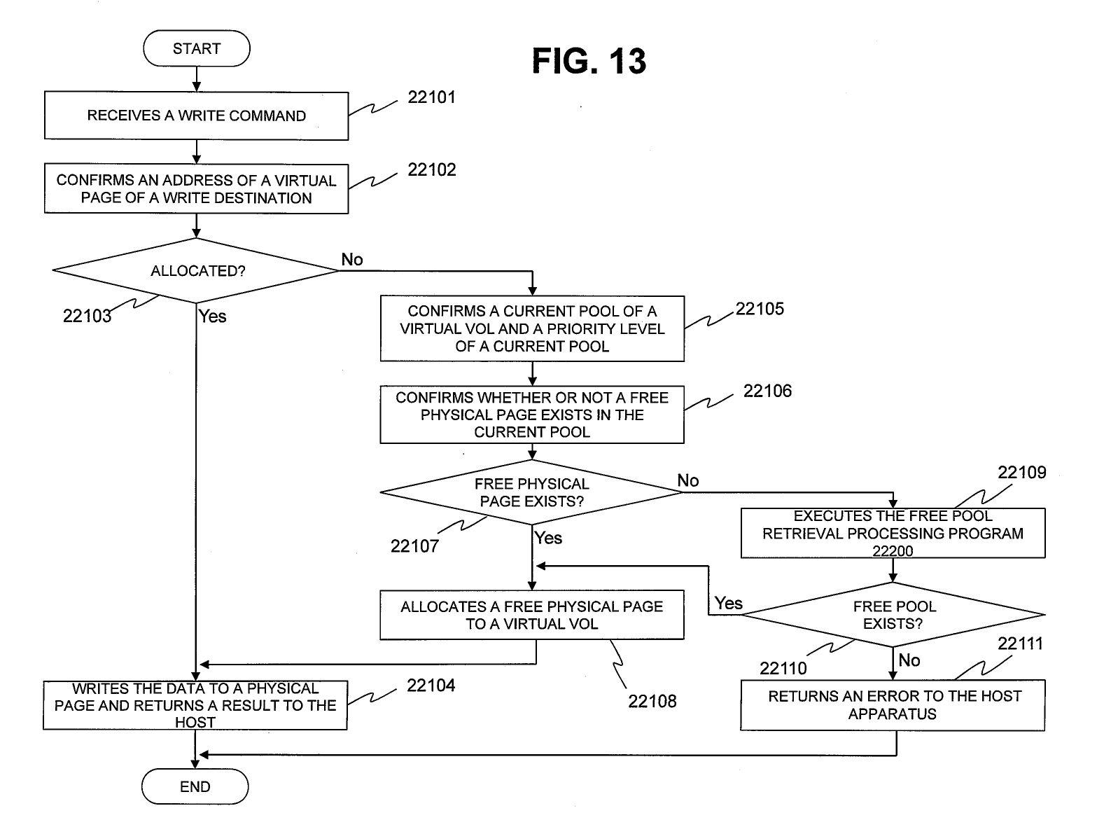

The process procedures in accordance with the present embodiment will be described in the following with reference to the flowcharts shown in FIGS. 13 to 16.

FIG. 13 is a flowchart showing a write process procedure that is executed by the I/O processing program 22100.

In a step 22101, the controller 10 (the host apparatus I/F 25000) receives a write command and the write target data from a host apparatus. For instance, the write command includes the write destination information provided with an identification number of a VOL of a write destination (for instance, a LUN (Logical Unit Number)) and an address of an area of a write destination (for instance, an LBA (Logical Block Address)).

In a step 22102, the I/O processing program 22100 specifies a virtual VOL of a write destination and a virtual page of a write destination based on the write destination information that is included in the write command that has been received.

In a step 22103, the processor 21000 judges whether or not the virtual page that has been specified in the step 22102 is a virtual page that has been allocated based on the virtual VOL map information table 22800. In the case in which the pool number 22840 and a page number 22850 in a pool that are not N/A is corresponded to the virtual page, a virtual page of a write destination is a virtual page that has been allocated. In the case in which a result of the judgment is positive (step 22103: Yes), a step 22104 is executed. On the other hand, in the case in which a result of the judgment is negative (step 22103: No), that is, in the case in which a virtual page of a write destination is a virtual page that has not been allocated, a step 22105 is executed.

In a step 22104, the processor 21000 writes the write target data to a physical page that has been allocated to a virtual page of a write destination, and returns an execution result (write successful) to the host apparatus 10000. In the step 22101 described above, the processor 21000 can write the write target data that has been received to a memory 22000 (a cache memory area), and can return an execution result of write successful to the host apparatus.

In a step 22105, the processor 21000 refers to the virtual VOL configuration management table 22400, and specifies a current pool of a virtual VOL of a write destination and a priority level of a current pool for a write destination virtual VOL from the current pool 22450 that is corresponded to a virtual VOL of a write destination and the pool number 22460.

In a step 22106, the processor 21000 confirms whether or not there is a free physical page in the current pool 27000 that has been specified in the step 22105 based on the pool map information table 22900.

In the case in which a free physical page exists in the current pool (step 22107: Yes), a step 22108 is executed. In the case in which a free physical page does not exist in the current pool (step 22107: No), a step 22109 is executed.

In the step 22108, the processor 21000 allocates a free physical page in the current pool to a virtual VOL of a write destination (a virtual page of a write destination). After that, the step 22104 is executed.

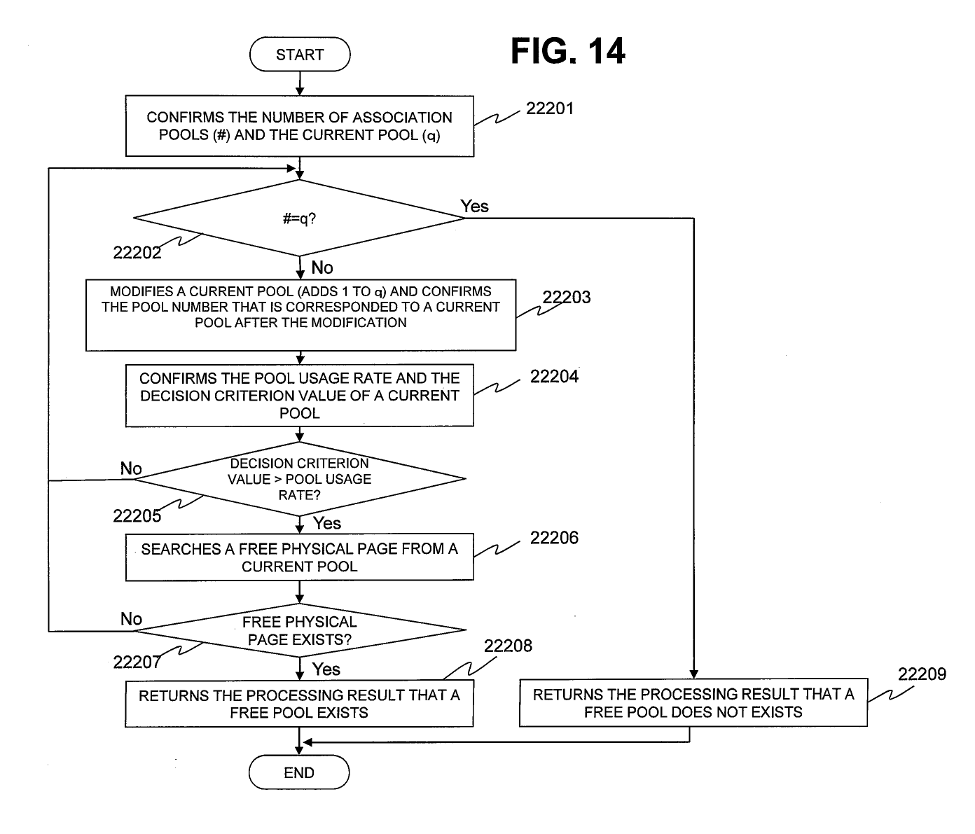

In the step 22109, since a free physical page does not exist in the current pool, the processor 21000 executes the free pool retrieval processing program 22200 (for more information, see the flowchart shown in FIG. 14). This is because a free pool (a pool provided with a free physical page) is searched from at least other one pool that is associated with a virtual VOL of a write destination. After that, the step 22110 is executed.

In a step 22110, the processor 21000 judges whether or not a free pool exists in at least one pool other than the current pool for a virtual VOL of a write destination based on the execution result of the free pool retrieval processing program 22200.

In the case in which a free pool exists (step 22110: Yes), a step 22108 is executed. In other words, the I/O processing program 22100 allocates a physical page to a virtual page of a write destination from a free pool (a current pool after a modification).

In the case in which a free pool does not exist (step 22110: No), a step 22111 is executed. In other words, the processor 21000 returns an error to the host apparatus 10000.

FIG. 14 is a flowchart showing a free pool retrieval process procedure that is executed by the free pool retrieval processing program 22200. The flowchart shows the detail of the step 22109 of FIG. 13.

In a step 22201, the processor 21000 refers to the virtual VOL configuration management table 22400, and confirms the number of association pools 22440 and the current pool 22450.

In a step 22202, the processor 21000 compares the number of association pools 22440 that has been confirmed in the step 22201 and a part of the numerical value of the current pool 22450 with each other, and judges whether or not the number of association pools 22440 and the part of the numerical value of the current pool 22450 are corresponded to each other. The correspondence of them means that the pool that requires the processes of the step 22203 and subsequent steps does not exist for the pools that have been allocated to a virtual page of a write destination. In the case in which they are corresponded to each other (step 22202: Yes), a step 22209 is executed. In the case in which they are not corresponded to each other (step 22202: No), a step 22203 is executed.

In a step 22203, the processor 21000 degrades a priority level indicated by the current pool 22450 that is corresponded to a virtual VOL of a write destination by one level (adds 1 to q of the priority level Pq). By this step, the current pool 22450 is upgraded. The processor 21000 specifies a pool (that is, a pool that newly becomes a current pool) 27000 that is corresponded to the upgraded current pool 22450 for the pool number 22460 that is corresponded to a virtual VOL of a write destination.

In a step 22204, the processor 21000 refers to the pool configuration management table 22500, and confirms the pool usage rate 22540 and the decision criterion value 22550 that is corresponded to the pool 27000 that has been specified in the step 22203.

In a step 22205, the processor 21000 compares the pool usage rate 22540 and the decision criterion value 22550 that have been confirmed in the step 22204 with each other, and judges whether or not the pool usage rate 22540 exceeds the decision criterion value 22550. In the case in which the pool usage rate 22540 exceeds the decision criterion value 22550 (step 22205: Yes), a step 22202 is executed again. In other words, even in the case in which a free physical page exists in a pool that has been specified in the step 22203, the processor 21000 does not allocate the free physical page from the pool to a virtual VOL of a write destination. On the other hand, in the case in which the pool usage rate 22540 does not exceed the decision criterion value 22550 (step 22205: No), a step 22206 is executed.

In a step 22206, the processor 21000 refers to the pool map information table 22900, and confirms whether or not a free physical page exists in the pool 27000 that has been specified in the step 22203.

In the case in which a free physical page exists in the pool 27000 that has been specified in the step 22203 (step 22207: Yes), a step 22208 is executed again. On the other hand, in the case in which a free physical page does not exist in the pool 27000 that has been specified in the step 22203 (step 22207: No), a step 22202 is executed.

In the step 22208, the processor 21000 returns the processing result that a free pool exists for a virtual VOL 26000 of a write destination to an execution source (the I/O processing program 22100).

In the step 22209, the processor 21000 returns the processing result that a free pool does not exists to an execution source.

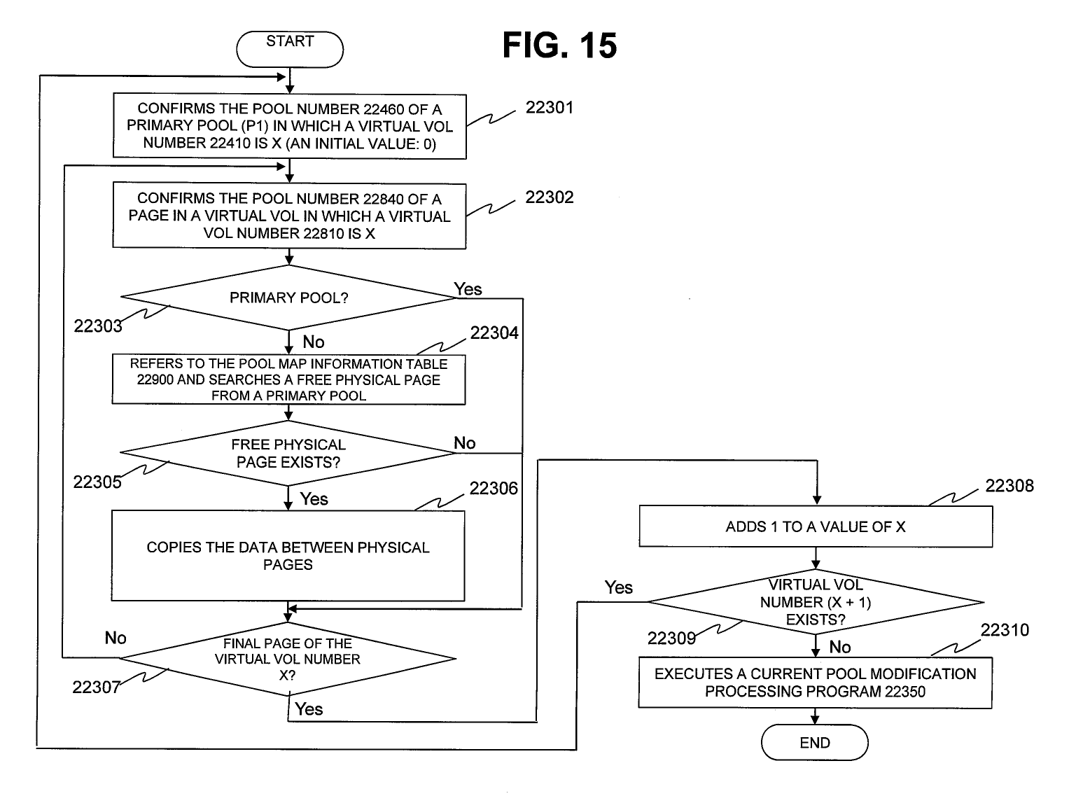

FIG. 15 is a flowchart showing a configuration optimization process procedure that is executed by the configuration optimization processing program 22300. The process procedure is started on a periodic basis for instance.

The configuration optimization processing program 22300 copies data from a physical page (a copy source page) in the pool 27000 other than a primary pool to a free physical page (a copy destination page) in a primary pool (that is, relocates data) for each of virtual VOLs. The configuration optimization processing program 22300 then updates the virtual VOL map information table 22800 in such a manner that a copy destination page as substitute for a copy source page is allocated to a virtual page to which a copy page has been allocated.

The configuration optimization processing program 22300 executes the processing for increasing a free capacity of a primary pool for each of virtual VOLs. As the processing for increasing a free capacity, there can be mentioned for instance a method for extending a capacity of a primary pool by adding a pool VOL 28000 to a primary pool and a method for executing a zero data deletion for a primary pool. The zero data deletion means that a physical page that has stored zero data (data in which a value of each bit is “0”) of physical pages that have been allocated is released from the virtual VOL. Since the released physical page becomes a free physical page, a free capacity of a pool is increased.

In the state in which a free capacity of the primary pool is depleted, data is not copied from a physical page in a pool other than a primary pool to a physical page in a primary pool since a free physical page does not exist in a primary pool.

In a step 22301, the processor 21000 refers to the virtual VOL configuration management table 22400, and confirms the pool number 22460 of a primary pool (P1) in which a virtual VOL number 22410 is X (an initial value: 0). In other words, the processor 21000 specifies a primary pool that is corresponded to a virtual VOL #X.

In a step 22302, the processor 21000 refers to the virtual VOL map information table 22800, and confirms the pool number 22840 that is corresponded to a virtual page in a virtual VOL 26000 in which a virtual VOL number 22410 is X. In other words, the processor 21000 specifies a pool provided with a physical page that is allocated to a virtual VOL #X.

In a step 22303, the processor 21000 judges whether or not the pool number 22460 (a primary pool) that has been confirmed in the step 22301 and the pool number 22840 that has been confirmed in the step 22302 are corresponded to each other. In other words, the processor 21000 judges whether or not the pool that has been specified in the step 22301 and the pool that has been specified in the step 22302 are equivalent to each other.

In the case in which they are corresponded to each other (step 22303: Yes), a step 22307 is executed. In the case in which they are not corresponded to each other (step 22303: No), a step 22304 is executed.

In a step 22304, the processor 21000 refers to the pool map information table 22900, and searches a free physical page from a primary pool. Here, a reference destination can be the pool configuration management table 22500, and the processor 21000 can confirm a pool free capacity 22530. The processing in the case in which the pool map information table 22900 is referred to will be described in the following.

In the case in which a free physical page exists in a primary pool (step 22305: Yes), a step 22306 is executed. In the case in which a free physical page does not exist in a primary pool (step 22305: No), a step 22307 is executed.

In the step 22306, the processor 21000 copies the data that exists in a physical page in a pool other than a primary pool to a free physical page that exists in a primary pool for a virtual VOL #X. After the copy is completed, the processor 21000 modifies the pool number 22840 of a copy source page of the virtual VOL map information table 22800 and the page number 22850 in a pool to the pool number 22840 of a copy destination page (a page of a primary pool) and the page number 22850 in the pool. By this step, a copy source page becomes a free physical page. At this point of time, the zero data (data in which a value of each bit is “0”) can also be written to the copy source page (the copy source page can be initialized).

In a step 22307, the processor 21000 refers to the page number in the virtual VOL of the virtual VOL map information table 22800, and judges whether or not a virtual page of a processing target is the final page of the virtual VOL #X. In the case in which a virtual page of a processing target is the final page of the virtual VOL #X (step 22307: Yes), a step 22308 is executed. In the case in which a virtual page of a processing target is not the final page of the virtual VOL #X (step 22307: No), a step 22302 is executed again.

In the step 22308, the processor 21000 adds 1 to a value of X, and confirms a virtual VOL in which a virtual VOL number 22410 is X+1 (the virtual VOL #X (X=(X+1)). In a step 22308, the processor 21000 refers to a virtual VOL number 22410 of the virtual VOL configuration management table 22400, and judges whether or not a virtual VOL in which a virtual VOL number 22410 is X+1 exists. Here, a reference destination can be a virtual VOL number 22810 of the virtual VOL map information table 22800. The processing in the case in which the virtual VOL configuration management table 22400 is referred to will be described in the following.

In the case in which a virtual VOL in which a virtual VOL number 22410 is X+1 exists (step 22309: Yes), a step 22301 is executed. In the case in which a virtual VOL number 22410 is X+1 does not exist (step 22309: No), a step 22310 is executed.

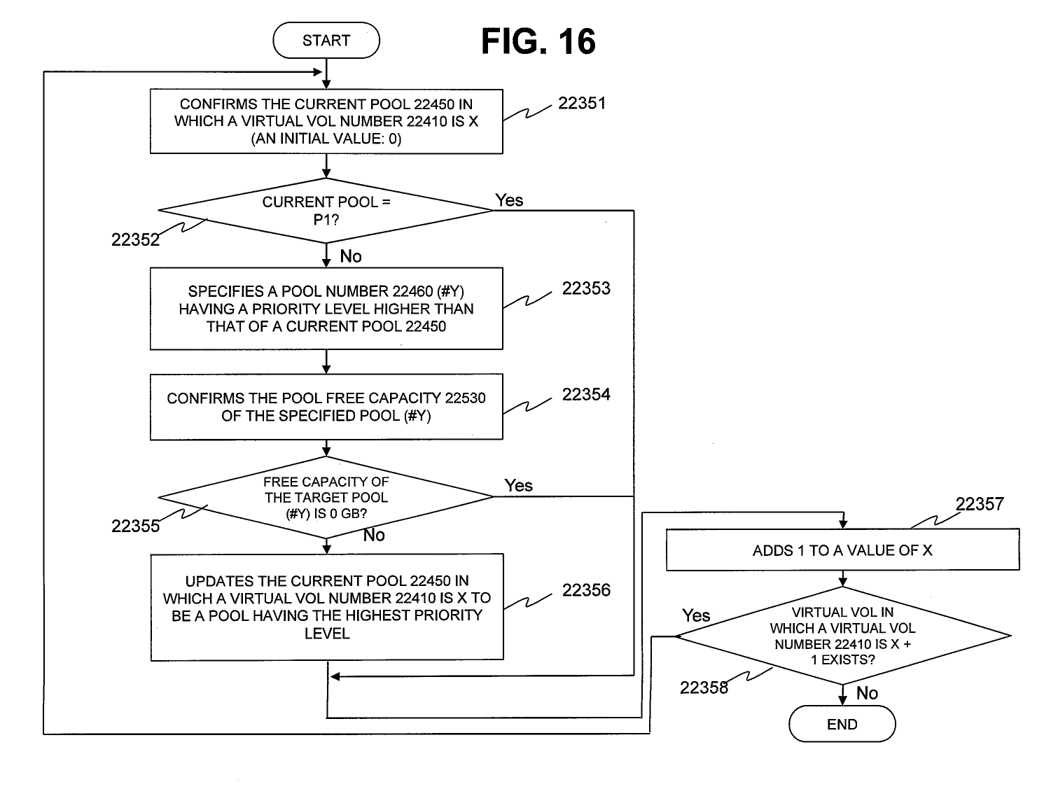

In the step 22310, the processor 21000 executes a current pool modification processing program 22350 (for more information, see the flowchart shown in FIG. 16). In other words, in the case in which there is a free physical page in a pool having a priority level higher than that of a current pool for each of virtual VOLs, the current pool is modified to the pool having a priority level higher than that of the current pool.

FIG. 16 is a flowchart showing a current pool modification process procedure that is executed by the current pool modification processing program 22350.

The current pool modification processing program 22350 executes the processing for modifying a current pool to a pool having a higher priority level (such as an upper level pool of a third pool, a primary pool, and a secondary pool).

The current pool modification processing program 22350 can be executed in the case in which a free capacity of a primary pool is increased or in a configuration optimization process procedure for instance.

In a step 22351, the processor 21000 refers to the virtual VOL configuration management table 22400, and confirms the current pool 22450 in which a virtual VOL number 22410 is X (an initial value: 0).

In a step 22352, the processor 21000 judges whether or not the current pool 22450 that has been confirmed in the step 22351 is P1 (whether or not the current pool is a primary pool). In the case in which the current pool is a primary pool (step 22352: Yes), a step 22357 is executed. In the case in which the current pool is a pool other than a primary pool (step 22352: No), a step 22353 is executed.

In the step 22353, the processor 21000 refers to the virtual VOL configuration management table 22400, and specifies at least one pool #Y having a priority level higher than that of a current pool for a virtual VOL #X.

In the step 22354, the processor 21000 refers to the pool configuration management table 22500, and confirms the pool free capacity 22530 of at least one pool #Y that has been specified in the step 22353. Here, a reference destination can be the pool map information table 22900 and the virtual VOL allocation existence or nonexistence 22950 can be confirmed. The processing in the case in which the pool configuration management table 22500 is referred to will be described in the following.

In a step 22355, the processor 21000 judges whether or not the free capacity 22530 of at least one pool #Y that has been specified in the step 22354 is 0 GB. In the case in which the free capacity 22530 of at least one pool #Y that has been specified in the step 22354 is 0 GB (step 22355: Yes), a step 22357 is executed. In the case in which the free capacity 22530 of at least one pool #Y that has been specified in the step 22354 is a value other than 0 GB (step 22355: No), a step 22356 is executed.

In the step 22356, the processor 21000 refers to the virtual VOL configuration management table 22400, and updates the current pool 22450 in which a virtual VOL number 22410 is X to be a priority level of a pool having the highest priority level among at lest one pool #Y in which the pool free capacity 22530 is a value other than 0 GB.

In the step 22357, the processor 21000 adds 1 to a value of X.

In the step 22358, the processor 21000 refers to a virtual VOL number 22410 of the virtual VOL configuration management table 22400, and judges whether or not a virtual VOL in which a virtual VOL number 22410 is X+1 exists. Here, a reference destination can be a virtual VOL number 22810 of the virtual VOL map information table 22800. The processing in the case in which the virtual VOL configuration management table 22400 is referred to will be described in the following.

In the case in which a virtual VOL in which a virtual VOL number 22410 is X+1 exists (step 22358: Yes), a step 22351 is executed. In the case in which a virtual VOL number 22410 is X+1 does not exist (step 22358: No), the current pool modification processing is completed.

While the preferred embodiments in accordance with the present invention have been described above, the present invention is not restricted to the embodiments, and various changes, modifications, and functional additions can be thus made without departing from the scope of the present invention.

What is claimed is:

1. A storage apparatus comprising:
a plurality of physical storage devices; and
a controller that is coupled to a host apparatus and the plurality of physical storage devices;
wherein the controller manages a plurality of virtual volumes and a plurality of pools that are associated with the plurality of virtual volumes,
wherein each of the virtual volumes is a virtual logical volume to which Thin Provisioning is applied, and is configured by a plurality of virtual areas,
wherein each of the pools is a storage area that is configured by a plurality of physical areas based on the plurality of physical storage devices,
wherein at least two virtual volumes of the plurality of virtual volumes are associated with at least one pool of the plurality of pools,
wherein at least two pools of the plurality of pools are associated with each of virtual volumes,
wherein at least two pools that are associated for each of virtual volumes have a priority level,
(A) the controller receives a write command and the write target data from the host apparatus, and
(B) in the case in which a virtual area of a write destination that is specified by the write command is an unallocated virtual area, based on the priority level of the at least two pools that are associated with a virtual volume of a write destination that is specified by the write command, the controller selects one pool from at least two pools, allocates an unallocated physical area in the selected pool to the virtual area of a write destination, and writes the write target data to the allocated physical area.

2. The storage apparatus according to claim 1, wherein:
each pool is provided with a usage rate threshold value that is compared with a usage rate of a pool;
a usage rate of a pool is a rate of the total capacity of a physical area that has been allocated for the pool to a capacity of the pool; and
in the case in which the pool that is selected is a pool other than a pool having the highest priority level for the virtual volume of a write destination in the (B), the selected pool is associated with a virtual volume other than the virtual volume of a write destination as a pool having the highest priority level, and the controller executes the following steps:
(b1) judging whether or not a usage rate of the selected pool exceeds a usage rate threshold value of the pool;
(b2) in the case in which the result of the judgment of the step (b1) is negative, allocating an unallocated physical area in the selected pool to the virtual area of a write destination and writing the write target data to the allocated physical area; and
(b3) in the case in which the result of the judgment of the step (b1) is positive, not allocating an unallocated physical area in the selected pool to the virtual area of a write destination.

3. The storage apparatus according to claim 2, wherein the controller selects a pool having a priority level lower than that of the selected pool from at least two pools that are associated with the virtual volume of a write destination in the step (b3) and executes the step (b1) for the selected pool.

4. The storage apparatus according to claim 3, wherein:
one of at least two pools that are associated for each virtual volume is a current pool that is a current allocation source of a physical area;
the selected pool in the (B) is a current pool; and
in the case in which the step (b3) is executed, the controller modifies the current pool for the virtual volume of a write destination to be the pool that is selected in the step (b3).

5. The storage apparatus according to claim 4, wherein the current pool is a pool having the highest priority level at first for each virtual volume.

6. The storage apparatus according to claim 1, wherein:
the controller executes the following steps in the (B):
(x1) judging whether or not an unallocated physical area exists in the selected pool;
(x2) in the case in which the result of the judgment of the step (x1) is positive, allocating the unallocated physical area in the selected pool to the virtual area of a write destination and writing the write target data to the allocated physical area; and
(x3) in the case in which the result of the judgment of the step (x1) is negative, selecting a pool having a priority level lower than that of the selected pool and executing the step (x1).

7. The storage apparatus according to claim 6, wherein:
one of at least two pools that are associated for each virtual volume is a current pool that is a current allocation source of a physical area;
the selected pool in the step (x1) is a current pool; and
in the case in which the step (x3) is executed, the controller modifies the current pool for the virtual volume of a write destination to the pool that is selected in step (x3).

8. The storage apparatus according to claim 7, wherein:
the controller judges for a virtual volume whether or not a physical page that can be allocated exists in a pool having a priority level higher than that of a current pool of the virtual volume; and
in the case in which the result of the judgment is positive, the pool is made to be a current pool.

9. The storage apparatus according to claim 6, wherein:
each pool is provided with a usage rate threshold value that is compared with a usage rate of a pool;
a usage rate of a pool is a rate of the total capacity of a physical area that has been allocated for the pool to a capacity of the pool; and
in the case in which the pool that is selected is a pool other than a pool having the highest priority level for the virtual volume of a write destination in the (B), the selected pool is associated with a virtual volume other than the virtual volume of a write destination as a pool having the highest priority level, and the controller executes the following steps in the step (x2):
(x21) judging whether or not a usage rate of the selected pool exceeds a usage rate threshold value of the pool;
(x22) in the case in which the result of the judgment of the step (x21) is negative, allocating an unallocated physical area in the selected pool to the virtual area of a write destination and writing the write target data to the allocated physical area; and
(x23) in the case in which the result of the judgment of the step (x21) is positive, selecting a pool having a priority level lower than that of the selected pool and executing the step (x1).

10. The storage apparatus according to claim 1, wherein:
the controller selects one virtual volume from the plurality of the virtual volumes and executes the following steps (f1) to (f3) for the selected virtual volume:
(f1) selecting a pool other than a pool having the highest priority level from at least two that are associated with the selected virtual volume;
(f2) judging whether or not a physical page that can be allocated exists in a pool having a priority level higher than that of the pool that is selected in the step (f1); and
(f3) in the case in which the result of the judgment of the step (f2) is positive, copying data from the physical area that is allocated to the selected virtual volume among the allocated physical areas for the pool that is selected in the step (f1) to a physical area in a pool having a priority level higher than that of the pool that is selected in the step (f1).

11. The storage apparatus according to claim 1, wherein a priority level of at least two pools that are associated for each virtual volume is a priority level that is determined based on a degree of importance of a plurality of host apparatuses that access the plurality of the virtual volumes.

12. The storage apparatus according to claim 11, wherein:
as a degree of importance of a host apparatus that accesses other virtual volume that is associated with a pool with which the virtual volume is associated is lower, a priority level other than the highest priority level among priority levels of at least three pools that are associated is higher for each virtual volume.

13. The storage apparatus according to claim 12, wherein:
in the case in which the degrees of importance of at least two host apparatuses that access at least two other virtual volumes that are associated with at least two pool other than a pool having the highest priority level are equivalent to each other for each virtual volume, as an access performance of a physical storage device that is a basis of the pool is higher, the priority level of the at least two pools is higher.

14. A storage control method of a system provided with a plurality of virtual volumes and a plurality of pools that are associated with the plurality of virtual volumes, comprising the steps of:
(A) receiving a write command and a write target data from the host apparatus; and
(B) in the case in which a virtual area of a write destination that is specified by the write command is an unallocated virtual area, based on a priority level of at least two pools that are associated with a virtual volume of a write destination that is specified by the write command, selecting one pool from the at least two pools, allocating an unallocated physical area in the selected pool to the virtual area of a write destination, and writing the write target data to the allocated physical area,
wherein each virtual volume is a virtual logical volume to which Thin Provisioning is applied and that is configured by a plurality of virtual areas;
each pool is a storage area that is configured by a plurality of physical areas based on the plurality of physical storage devices;
at least two virtual volumes of the plurality of virtual volumes are associated with at least one pool of the plurality of pools;
at least two pools of the plurality of pools are associated with each virtual volume; and
at least two pools that are associated have a priority level for each virtual volume.

15. A storage control apparatus comprising:
a first interface apparatus to a host apparatus;
a second interface apparatus to a plurality of physical storage devices;
a storage resource; and
a processor that is coupled to the first interface apparatus, the second interface apparatus, and the storage resource, wherein the processor manages a plurality of virtual volumes and a plurality of pools that are associated with the plurality of virtual volumes,
wherein each of the virtual volumes is a virtual logical volume to which Thin Provisioning is applied, and is configured by a plurality of virtual areas,
wherein each of the pools is a storage area that is configured by a plurality of physical areas based on the plurality of physical storage devices,
wherein at least two virtual volumes of the plurality of virtual volumes are associated with at least one pool of the plurality of pools,
wherein at least two pools of the plurality of pools are associated with each of virtual volumes,
wherein the storage resource stores the volume management information,
wherein the volume management information indicates a priority level of at least two pools that are associated for each of virtual volumes,
(A) the first interface apparatus receives a write command and the write target data from the host apparatus, and
(B) in the case in which a virtual area of a write destination that is specified by the write command is an unallocated virtual area, based on the priority level of the at least two pools that are associated with a virtual volume of a write destination that is specified by the write command, which is indicated by the volume management information, the processor selects one pool from at least two pools, allocates an unallocated physical area in the selected pool to the virtual area of a write destination, and writes the write target data to the allocated physical area via the second interface apparatus.
